(19) United States
(12) Patent Application Publication
(10) Pub. No.: US 2008/0310909 A1
(43) Pub. Date: Dec. 18, 2008

(54) Ring Binder

(76) Inventor: Jeong-Woo Park, Cheonan-City (KR)

Correspondence Address: IPLA P.A., 3580 WILSHIRE BLVD., 17TH FLOOR, LOS ANGELES, CA, 90010, US

(21) Appl. No.: 12/094,978

(22) PCT Filed: Dec. 8, 2005
(86) PCT No.: PCT/KR2005/004204

§ 371 Date: May 23, 2008

(30) Foreign Application Priority Data
Nov. 25, 2005 (KR) 10-2005-0113469
Dec. 8, 2005 (KR) PCT/KR2005/004204

(51) Int. Cl. B42F 13/20

(52) U.S. Cl. 402/34

(57) ABSTRACT

A ring binder includes at least two first and second pipes which are hollow inside; a first ring positioned at an end of the first pipe to be opened and closed; a second ring positioned between the first pipe and the second pipe to be opened and closed; a third ring positioned at an end of the second pipe to be opened and closed; and a support bar passing through the first and second pipes and the first through third rings and holding the first and third rings so that the first and third rings are not separated from the first and second pipes, wherein ends of first, second, and third stationary half rings are combined with and separated from ends of first, second, and third rotating half rings.

### TECHNICAL FIELD

The present invention relates to a ring binder for binding a document or book.

### BACKGROUND ART

FIG. 1 is an exploded perspective view of a conventional ring binder for binding a document. FIG. 2 shows a state in which the ring binder shown in FIG. 1 is assembled and two half rings are combined. FIG. 3 shows a state in which the two half rings shown in FIG. 2 are separated.

As shown in the drawings, the conventional ring binder includes a housing having a plurality of indentations 1a and 1b in a symmetric form, and being fixed at the center of a predetermined cover, a pair of carrier rails 2 and 3 whose sides facing each other closely contact each other, and half rings 4 and 5 respectively fixed at the carrier rails 2 and 3 and passing through the indentations 1a and 1b. Referring to FIG. 2, when the contact portion between the carrier rails 2 and 3 moves down, ends of the half rings 4 and 5 are combined. Referring to FIG. 3, when the contact portion between the carrier rails 2 and 3 moves up, the half rings 4 and 5 are separated from each other. In a state where the half rings 4 and 5 are separated from each other, the half rings 4 and 5 are inserted into holes formed in a document. Thereafter, when the half rings 4 and 5 are combined, the document is bound by the ring binder.

In the above-described conventional ring binder, a pair of the carrier rails 2 and 3 and the housing 1 are needed to combine or separate a pair of half rings. Due to the carrier rails or housing, the whole size of the ring binder increases. As a result, the size of a bound document unnecessarily increases. Moreover, the carrier rails or the housing may ruin the appearance of the document.

Furthermore, since the price of the ring binder increases due to the carrier rails 2 and 3 or the housing 1, the price of a calendar or a scheduler using the ring binder increases.

### DISCLOSURE OF THE INVENTION

The present invention provides a ring binder which does not use a carrier rail or a housing, thereby decreasing a size and price.

The present invention provides a ring binder which allows a bound document to be totally turned over and which can be used for any type of document.

According to an aspect of the present invention, there is provided a ring binder including at least two first and second pipes which are hollow inside, a first ring positioned at an end of the first pipe to be opened and closed, a second ring positioned between the first pipe and the second pipe to be opened and closed, a third ring positioned at an end of the second pipe to be opened and closed, and a support bar passing through the first and second pipes and the first through third rings and holding the first and third rings so that the first and third rings are not separated from the first and second pipes, wherein the first, second, and third rings comprise first, second, and third stationary half rings each fixed to at least one of the first and second pipes and first, second, and third rotating half rings each rotatable about at least one of the first and second pipes, and ends of the first, second, and third stationary half rings are combined with and separated from ends of the first, second, and third rotating half rings.

The first ring may include the first stationary half ring having at one end a first fixing portion welded and fixed to a left end of the first pipe and the first rotating half ring having at one end a first rotating portion that rotates in close contact with the first fixing portion. The second ring may include the second stationary half ring having at one end a second fixing portion welded and fixed to two ends of the respective first and second pipes and the second rotating half ring having at one end a second rotating portion inserted into the second fixing portion to be rotated. The third ring may include the third stationary half ring having at one end a third fixing portion welded and fixed to a right end of the second pipe and the third rotating half ring having at one end a third rotating portion that rotates in close contact with the third fixing portion. The first fixing portion of the first ring and the third fixing portion of the third ring may have [symbol] shaped cross-sections, the first rotating portion of the first ring and the third rotating portion of the third ring may have [symbol] shaped cross-sections, the second fixing portion of the second ring may have a “∩” shaped cross-section, and the second rotating portion of the second ring may have a [symbol] shaped cross-section. The second fixing portion may be thicker than the second stationary half ring.

The first through third rings may include the first, second, and third stationary half rings respectively, having at their one ends fixing portions, respectively, welded and fixed to the first and second pipes; and the first, second, and third rotating half rings, respectively, having at their one ends rotating portions inserted into the fixing portions, respectively, to be rotated. Other ends of the first stationary half rings may be combined with and separated from other ends of the rotating half rings. The fixing portions of the first through third rings may have “∩” shaped cross-sections and the rotating portions of the first through third rings may have [symbol] shaped cross-sections. The fixing portions may be thicker than the stationary half rings.

The support bar may have a polygonal cross-section. The first ring may include the first stationary half ring having a first fixing portion with a polygonal hole, through which the support bar passes so that the first stationary half ring does not rotate with respect to the support bar; and the first rotating half ring having at one end a first rotating portion, which rotates in close contact with the first fixing portion. The second ring may include the second stationary half ring having a second fixing portion with a polygonal hole, through which the support bar passes so that the second stationary half ring does not rotate with respect to the support bar; and the second rotating half ring having at one end a second rotating portion, which rotates in close contact with the second fixing portion. The third ring may include the third stationary half ring having a third fixing portion with a polygonal hole, through which the support bar passes so that the third stationary half ring does not rotate with respect to the support bar; and the third rotating half ring having at one end a third rotating portion, which rotates in close contact with the third fixing portion.

The support bar may include a head at one end to prevent the first ring from being separated from the first pipe and a nut at the other end to prevent the third ring from being separated from the second pipe, the other end of the support bar may be directly welded to the third ring, or the support bar may use a riveting method for pressing one or both ends, so that the first ring and the third ring are not separated from the first and second pipes.

The first through third stationary half rings may respectively include combining holes at their ends, and the first through third rotating half rings may respectively include combining protrusions inserted into the combining holes at their ends, so that the ends of the stationary half rings are combined with and separated from the ends of the rotating half rings, respectively.

### BRIEF DESCRIPTION OF THE DRAWINGS

FIG. 1 is an exploded perspective view of a conventional ring binder.

FIG. 2 shows a state in which the ring binder shown in FIG. 1 is assembled and two half rings are combined.

FIG. 3 shows a state in which the two half rings shown in FIG. 2 are separated.

FIG. 4 is a perspective view of a ring binder according to a first embodiment of the present invention.

FIG. 5 is an exploded perspective view of the ring binder shown in FIG. 4.

FIG. 6 is a cross sectional view of the ring binder, taken along the line VI-VI′ shown in FIG. 4.

FIG. 7 illustrates an enhanced second fixing portion thicker than a second fixing portion shown in FIG. 6.

FIG. 8 is a perspective view of a ring binder according to a second embodiment of the present invention.

FIG. 9 is an exploded perspective view of the ring binder shown in FIG. 8.

FIG. 10 is a cross sectional view of the ring binder, taken along the line X-X′ shown in FIG. 8.

FIG. 11 is a perspective view of a ring binder according to a third embodiment of the present invention.

FIG. 12 is an exploded perspective view of the ring binder shown in FIG. 11.

FIG. 13 is a cross sectional view of the ring binder, taken along the line XIII-XIII′ shown in FIG. 11.

### BEST MODE FOR CARRYING OUT THE INVENTION

Hereinafter, embodiments of the present invention will be described in detail with reference to the attached drawings.

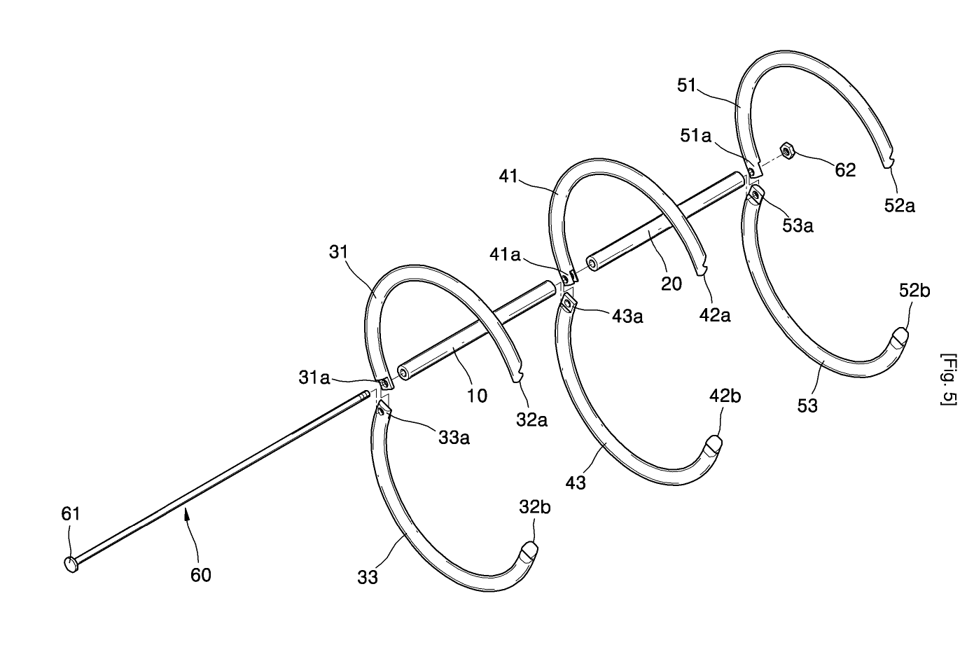

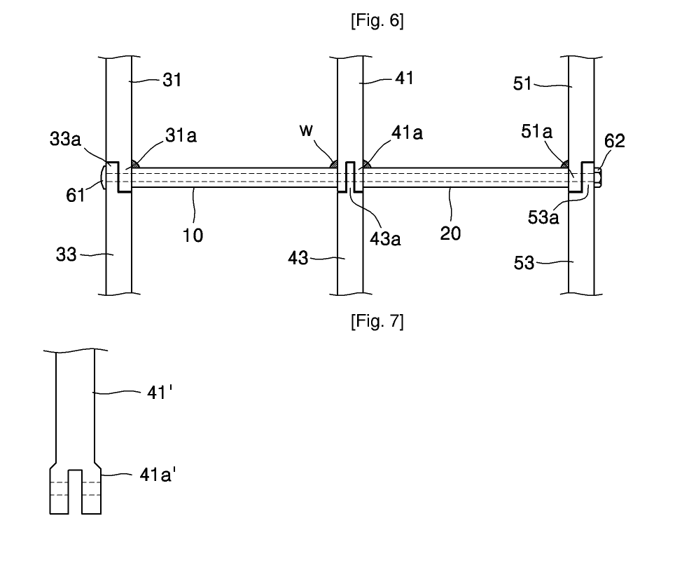

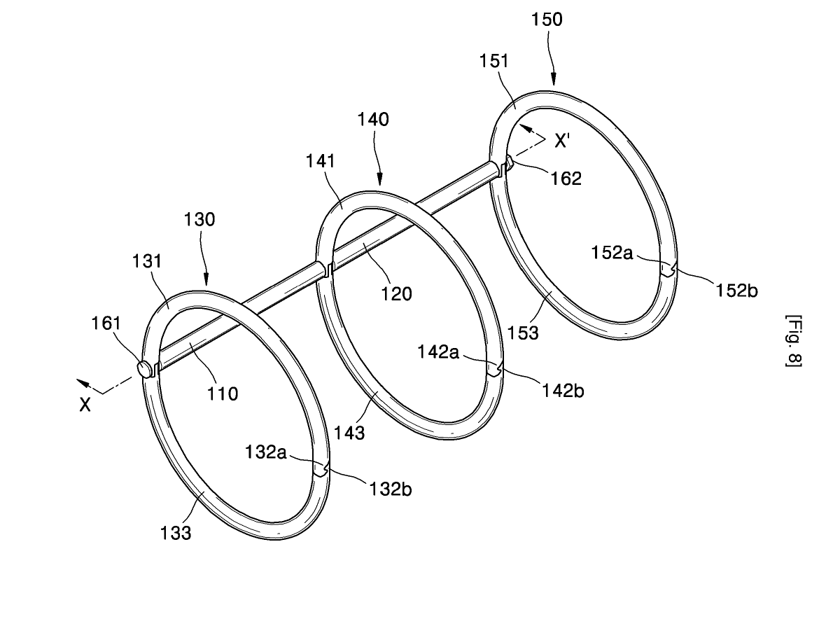

FIG. 4 is a perspective view of a ring binder according to a first embodiment of the present invention. FIG. 5 is an exploded perspective view of the ring binder shown in FIG. 4. FIG. 6 is a cross sectional view of the ring binder, taken along the line VI-VI′ shown in FIG. 4. FIG. 7 illustrates an enhanced second fixing portion thicker than a second fixing portion shown in FIG. 6.

The ring binder according to the first embodiment of the present invention includes at least two first and second pipes 10 and 20 which are hollow inside, a first ring 30 positioned on the left of the first pipe 10 to be opened and closed, a second ring 40 positioned between the first pipe 10 and the second pipe 20 to be opened and closed, a third ring 50 positioned on the right of the second pipe 20 to be opened and closed, and a support bar 60 passing through the first and second pipes 10 and 20 and the first through third rings 30, 40, and 50 and holding the first and third rings 30 and 50 so that the first and third rings 30 and 50 are not separated from the first and second pipes 10 and 20.

The first ring 30 includes a first stationary half ring 31 having at one end a first fixing portion 31a welded and fixed to the left end of the first pipe 10 and a first rotating half ring 33 having at one end a first rotating portion 33a that rotates in close contact with the first fixing portion 31a.

The second ring 40 includes a second stationary half ring 41 having at one end a second fixing portion 41 a welded and fixed to two ends of the respective first and second pipes 10 and 20 and a second rotating half ring 43 having at one end a second rotating portion 33a inserted into the second fixing portion 41 a to be rotated.

The third ring 50 includes a third stationary half ring 51 having at one end a third fixing portion 51a welded and fixed to the right end of the second pipe 20 and a third rotating half ring 53 having at one end a third rotating portion 53a that rotates in close contact with the third fixing portion 51a.

In the first and third rings 30 and 50, the first and third fixing portions 31a and 51a have [symbol] shaped cross-sections and the first and third rotating portions 33a and 53a have [symbol] shaped cross-sections.

In the second ring 40, the second fixing portion 41a has a “∩” shaped cross-section and the second rotating portion 43a has a [symbol] shaped cross-section. Referring to FIG. 7, a second fixing portion 41a′ may be thicker than a second stationary half ring 41′ to enhance the stiffness of the second fixing portion 41a′.

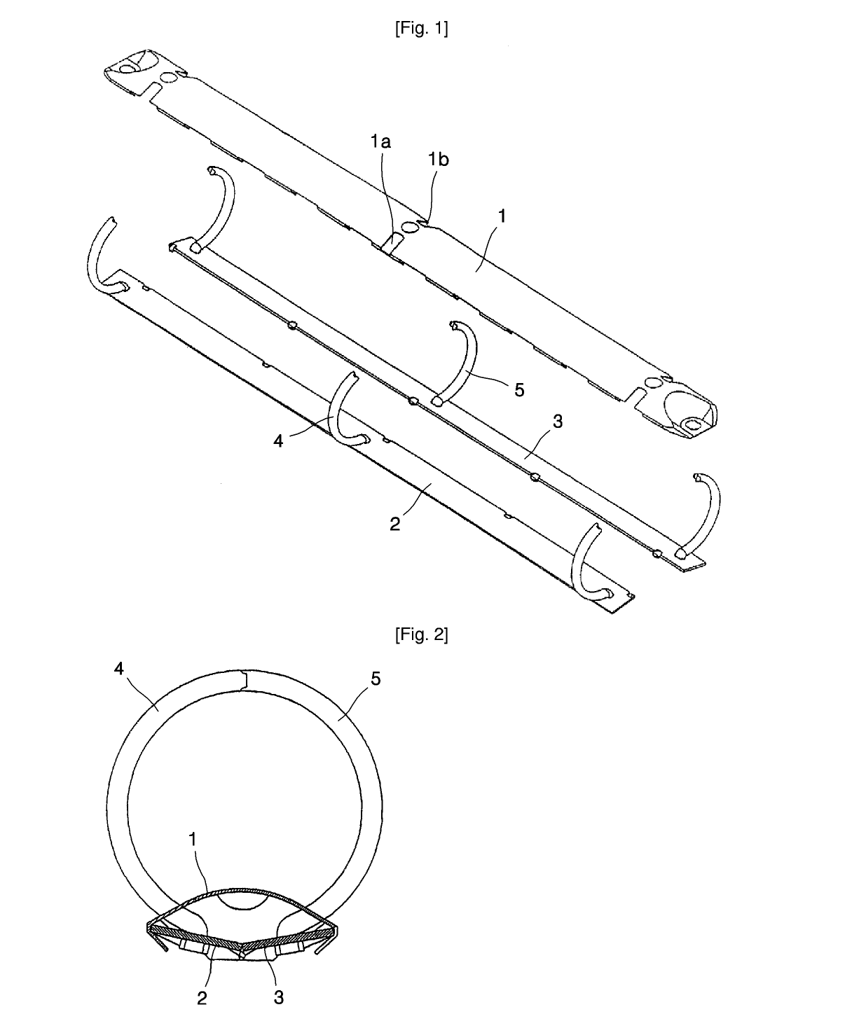

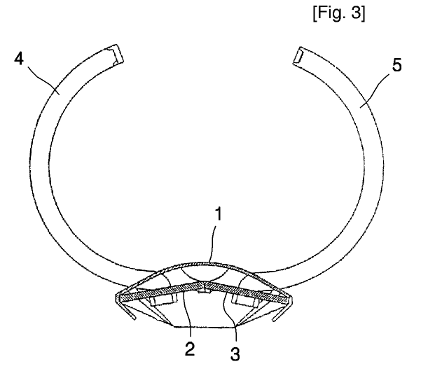

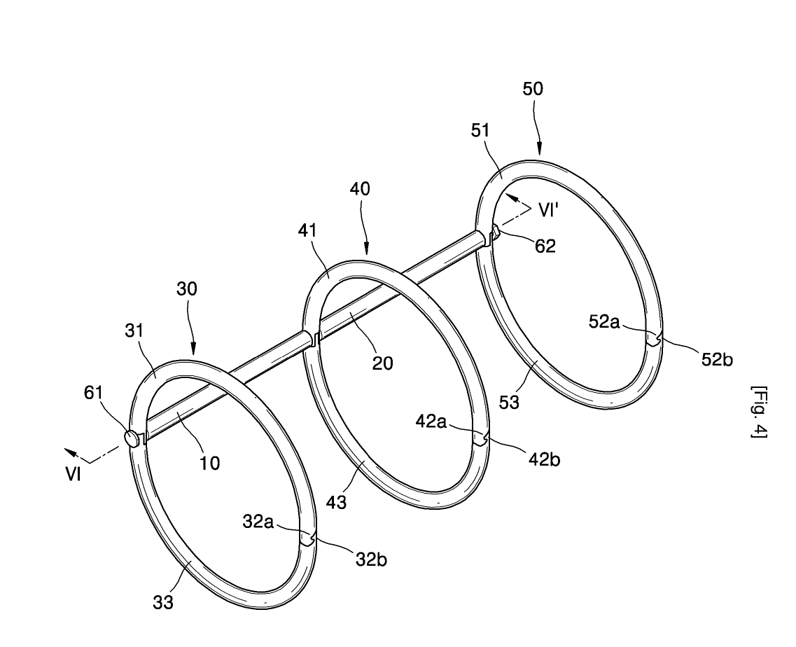

The other ends of the first through third stationary half rings 31, 41, and 51 can be combined with and separated from the other ends of the first through third rotating half rings 33, 43, and 53, respectively. For the combination and separation, hooks 32a, 42a, 52a, 32b, 42b, and 52bare formed at the ends, respectively, of the first through third stationary half rings 31, 41, and 51 and the first through third rotating half rings 33, 43, and 53, as shown in FIG. 1. Alternatively, combining holes (not shown) may be formed at the ends of the first through third stationary half rings 31, 41, and 51, respectively, while combining protrusions (not shown) inserted into the combining holes may be formed at the ends of the first through third rotating half rings 33, 43, and 53 so that the ends of the stationary half rings 31, 41, and 51 are combined with and separated from the ends of the rotating half rings 33, 43, and 53, respectively.

The support bar 60 includes a head 61 at one end to prevent the first ring 30 from being separated from the first pipe 10 and a nut 62 at the other end to prevent the third ring 50 from being separated from the second pipe 20. Alternatively, the other end of the support bar 60 may be directly welded to the third ring 50. As another alternative, the support bar 60 may use a riveting method for pressing one or both ends so that the first ring 30 and the third ring 50 are not separated from the first and second pipes 10 and 20. The support bar 60 presses the first and third rings 30 and 50 at their respective ends so that the first through third rotating half rings 33, 43, and 53 are not loosened from the first through third stationary half rings 31, 41, and 51, respectively, and are not rotated well with respect thereto.

In the first through third rings 30, 40, and 50, the first through third fixing portions 31a, 41a, and 51a are welded and fixed to the first and second pipes 10 and 20, and therefore, relative positions of the first through third stationary half rings 31, 41, and 51 are fixed. In other words, the first through third rotating half rings 33, 43, and 53 rotate around the fixed first through third stationary half rings 31, 41, and 51, respectively, so that the first through third rings 30, 40, and 50 are opened and closed.

Meanwhile, the first and second pipes 10 and 20 and the first through third rings 30, 40, and 50 may be made using steel or reinforced plastics and may be coated with metal to realize a good appearance.

In the first embodiment of the present invention, three rings are included, lo but more than three rings may be included.

Hereinafter, a ring binder according to a second embodiment of the present invention will be described.

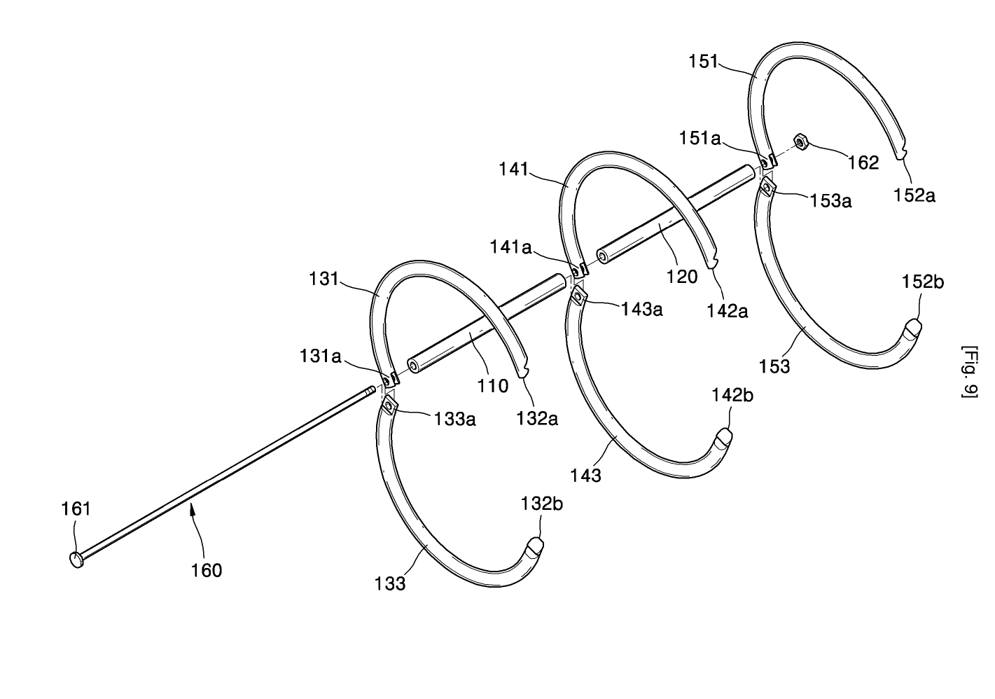

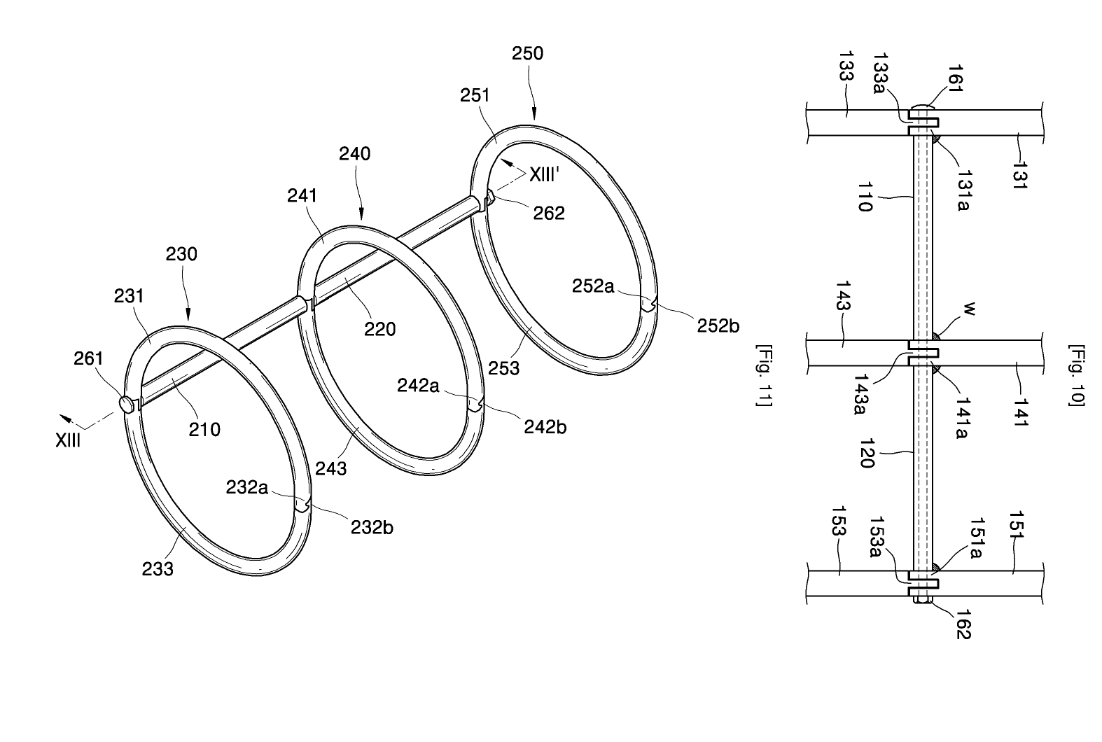

FIG. 8 is a perspective view of a ring binder according to the second embodiment of the present invention. FIG. 9 is an exploded perspective view of the ring binder shown in FIG. 8. FIG. 10 is a cross sectional view of the ring binder, taken along the line X-X′ shown in FIG. 8.

The ring binder according to the second embodiment of the present invention includes at least two first and second pipes 110 and 120 which are hollow inside, a first ring 130 positioned on the left of the first pipe 110 to be opened and closed, a second ring 140 positioned between the first pipe 110 and the second pipe 120 to be opened and closed, a third ring 150 positioned on the right of the second pipe 120 to be opened and closed, and a support bar 160 passing through the first and second pipes 110 and 120 and the first through third rings 130, 140, and 150 and holding the first and third rings 130 and 150 so that the first and third rings 130 and 150 are not separated from the first and second pipes 110 and 120.

The first through third rings 130, 140, and 150 include first, second, and third stationary half rings 131, 141, and 151, respectively, having at their one ends fixing portions 131a, 141a, and 151a, respectively, welded and fixed to the first and second pipes 110 and 120; and first, second, and third rotating half rings 133, 143, and 153, respectively, having at their one ends rotating portions 133a, 143a, and 153a inserted into the fixing portions 131a, 141a, and 151a, respectively, to be rotated.

In the first through third rings 130, 140, and 150, the fixing portions 131a, 141a, and 151a have a “∩” shaped cross-section and the rotating portions 133a, 143a, and 153a have a [symbol] shaped cross-section. As is illustrated in FIG. 7, a fixing portion may be thicker than a stationary half ring to enhance the stiffness of the fixing portion.

The other ends of the first through third stationary half rings 131, 141, and 151 can be combined with and separated from the other ends of the first through third rotating half rings 133, 143, and 153, respectively. For the combination and separation, hooks 132a, 142a, 152a, 132b, 142b, and 152b are formed at the ends, respectively, of the first through third stationary half rings 131, 141, and 151 and the first through third rotating half rings 133, 143, and 153, as shown in FIG. 5.

The support bar 160 includes a head 161 at one end to prevent the first ring 130 from being separated from the first pipe 110 and a nut 162 at the other end to prevent the third ring 150 from being separated from the second pipe 120. Alternatively, the other end of the support bar 160 may be directly welded to the third ring 150. As another alternative, the support bar 160 may use a riveting method for pressing one or both ends so that the first ring 130 and the third ring 150 are not separated from the first and second pipes 110 and 120. The support bar 160 presses the first and third rings 130 and 150 at their respective ends so that the first through third rotating half rings 133, 143, and 153 are not loosened from the first through third stationary half rings 131, 141, and 151, respectively, and are not rotated well with respect thereto. Furthermore, since the fixing portions 131a, 141a, and 151a have the “∩” shaped cross-section and the rotating portions 133a, 143a, and 153a have the [symbol] shaped cross-section, the first through third rotating half rings 133, 143, and 153 are prevented from rotating with respect to the first through third stationary half rings 131, 141, and 151, respectively.

Here, as is illustrated in FIG. 7, a fixing portion may be thicker than a stationary half ring to enhance the stiffness of the fixing portion.

In the first through third rings 130, 140, and 150, the fixing portions 131a, 141a, and 151a are welded and fixed to the first and second pipes 110 and 120, and therefore, relative positions of the first through third stationary half rings 131, 141, and 151 are fixed. In other words, the first through third rotating half rings 133, 143, and 153 rotate around the fixed first through third stationary half rings 131, 141, and 151, respectively, so that the first through third rings 130, 140, and 150 are opened and closed.

Meanwhile, the first and second pipes 110 and 120 and the first through third rings 130, 140, and 150 may be made using steel or reinforced plastics and may be coated with metal to realize a good appearance.

In the second embodiment of the present invention, three rings are included, but more than three rings may be included.

Hereinafter, a ring binder according to a third embodiment of the present invention will be described.

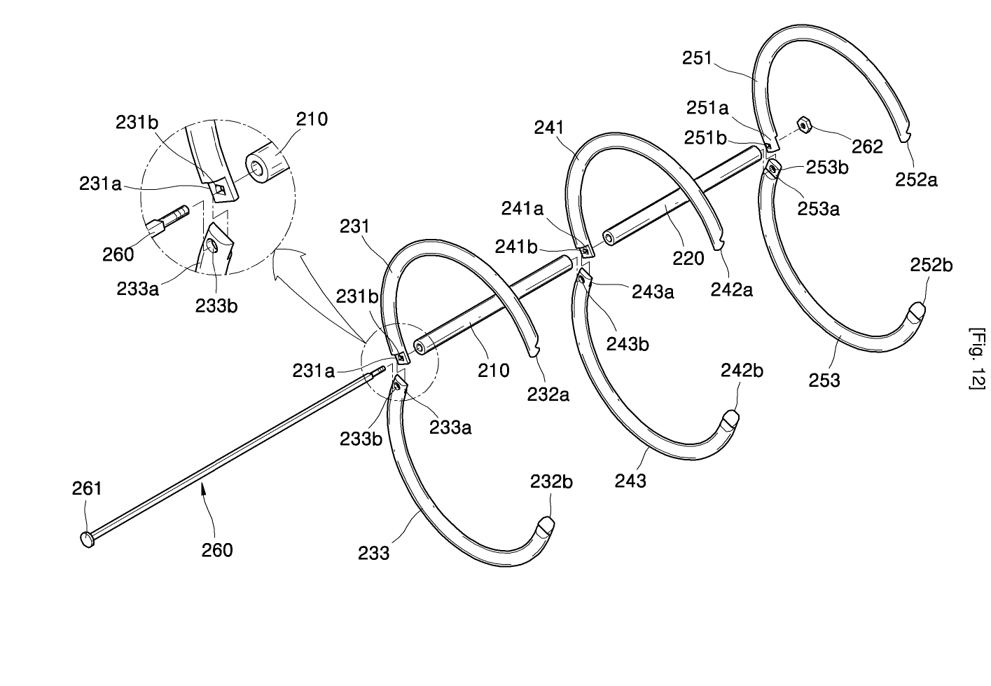

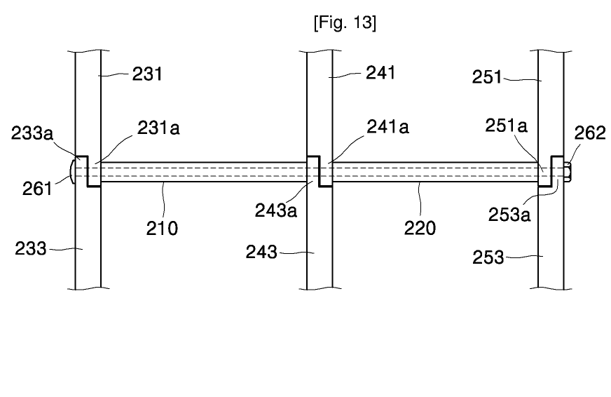

FIG. 11 is a perspective view of a ring binder according to the third embodiment of the present invention. FIG. 12 is an exploded perspective view of the ring binder shown in FIG. 11. FIG. 13 is a cross sectional view of the ring binder, taken along the line XIII-XIII′ shown in FIG. 11.

The ring binder according to the third embodiment of the present invention includes at least two first and second pipes 210 and 220 which are hollow inside, a first ring 230 positioned on the left of the first pipe 210 to be opened and closed, a second ring 240 positioned between the first pipe 210 and the second pipe 220 to be opened and closed, a third ring 250 positioned on the right of the second pipe 220 to be opened and closed, and a support bar 260 passing through the first and second pipes 210 and 220 and the first through third rings 230, 240, and 250 and holding the first and third rings 230 and 250 so that the first and third rings 230 and 250 are not separated from the first and second pipes 210 and 220.

The support bar 260 has a polygonal cross-section. In the description below, it is assumed that the support bar 260 has a tetragonal cross-section. However, the cross-section of the support bar 260 may be a triangle, a pentagon, a hexagon, or the like.

The first ring 230 includes a first stationary half ring 231 having a first fixing portion 231a with a polygonal hole 231b, through which the support bar 260 passes so that the first stationary half ring 231 does not rotate with respect to the support bar 260; and a first rotating half ring 233 having at one end a first rotating portion 233a, which rotates in close contact with the first fixing portion 231a. A circular hole 233b is formed in the first rotating portion 233a.

The second ring 240 includes a second stationary half ring 241 having a second fixing portion 241a with a polygonal hole 241b, through which the support bar 260 passes so that the second stationary half ring 241 does not rotate with respect to the support bar 260; and a second rotating half ring 243 having at one end a second rotating portion 243a, which rotates in close contact with the second fixing portion 241a. A circular hole 243b is formed in the second rotating portion 243a.

The third ring 250 includes a third stationary half ring 251 having a third fixing portion 251a with a polygonal hole 251b, through which the support bar 260 passes so that the third stationary half ring 251 does not rotate with respect to the support bar 260; and a third rotating half ring 253 having at one end a third rotating portion 253a, which rotates in close contact with the third fixing portion 251a. A circular hole 253b is formed in the third rotating portion 253a.

The support bar 260 includes a head 261 at one end to prevent the first ring 230 from being separated from the first pipe 210 and a nut 262 at the other end to prevent the third ring 250 from being separated from the second pipe 220. Alternatively, the other end of the support bar 260 may be directly welded to the third ring 250. As another alternative, the support bar 260 may use a riveting method for pressing one or both ends so that the first ring 230 and the third ring 250 are not separated from the first and second pipes 210 and 220.

In the first through third rings 230, 240, and 250, the polygonal holes 231b, 241b, and 251b are formed at the centers of the first through third fixing portions 231a, 241a, and 251a, respectively, and the circular holes 233b, 243b, and 253b are formed at the centers of the first through third rotating portions 233a, 243a, and 253a, respectively. The support bar 260 having the polygonal cross-section passes through the polygonal holes 231b, 241b, and 251b and the circular holes 233b, 243b, and 253b, and therefore, the first through third stationary half rings 231, 241, and 251 are fixed with respect to the support bar 260 while the first through third rotating half rings 233, 243, and 253 can be rotated with respect thereto. Accordingly, since the first through third rotating half rings 233, 243, and 253 are rotated with respect to the first through third stationary half rings 231, 241, and 251, respectively, the first through third rings 230, 240, and 250 can be opened and closed.

Meanwhile, the first and second pipes 210 and 220 and the first through third rings 230, 240, and 250 may be made using steel or reinforced plastics and may be coated with metal to realize a good appearance.

In the third embodiment of the present invention, three rings are included, but more than three rings may be included.

### INDUSTRIAL APPLICABILITY

According to the present invention, a ring binder does not include a carrier rail or a housing, and therefore, the size and price of the ring binder can be decreased. In addition, the ring binder allows a bounded document to be totally turned over, thereby increasing utility. The ring binder according to the present invention can be widely used for any type of documents.

1. A ring binder comprising:
at least two first and second pipes which are hollow inside;
a first ring positioned at an end of the first pipe to be opened and closed;
a second ring positioned between the first pipe and the second pipe to be opened and closed;
a third ring positioned at an end of the second pipe to be opened and closed; and
a support bar passing through the first and second pipes and the first through third rings and holding the first and third rings so that the first and third rings are not separated from the first and second pipes,
wherein the first, second, and third rings comprise first, second, and third stationary half rings each fixed to at least one of the first and second pipes and first, second, and third rotating half rings each rotatable about at least one of the first and second pipes, and ends of the first, second, and third stationary half rings are combined with and separated from ends of the first, second, and third rotating half rings.

2. The ring binder of claim 1, wherein the first ring comprises the first stationary half ring having at one end a first fixing portion welded and fixed to a left end of the first pipe and the first rotating half ring having at one end a first rotating portion that rotates in close contact with the first fixing portion,
the second ring comprises the second stationary half ring having at one end a second fixing portion welded and fixed to two ends of the respective first and second pipes and the second rotating half ring having at one end a second rotating portion inserted into the second fixing portion to be rotated, and
the third ring comprises the third stationary half ring having at one end a third fixing portion welded and fixed to a right end of the second pipe and the third rotating half ring having at one end a third rotating portion that rotates in close contact with the third fixing portion.

3. The ring binder of claim 2, wherein the first fixing portion of the first ring and the third fixing portion of the third ring have [symbol] shaped cross-sections, the first rotating portion of the first ring and the third rotating portion of the third ring have [symbol] shaped cross-sections, the second fixing portion of the second ring has a “∩” shaped cross-section, and the second rotating portion of the second ring has a [symbol] shaped cross-section.

4. The ring binder of claim 3, wherein the second fixing portion is thicker than the second stationary half ring.

5. The ring binder of claim 1, wherein the first through third rings comprise the first, second, and third stationary half rings respectively, having at their one ends fixing portions, respectively, welded and fixed to the first and second pipes; and the first, second, and third rotating half rings, respectively, having at their one ends rotating portions inserted into the fixing portions, respectively, to be rotated, and
other ends of the first stationary half rings are combined with and separated from other ends of the rotating half rings.

6. The ring binder of claim 5, wherein the fixing portions of the first through third rings have “∩” shaped cross-sections and the rotating portions of the first through third rings have [symbol] shaped cross-sections.

7. The ring binder of claim 6, wherein the fixing portions are thicker than the stationary half rings.

8. The ring binder of claim 1, wherein the support bar has a polygonal cross-section,
the first ring comprises the first stationary half ring having a first fixing portion with a polygonal hole, through which the support bar passes so that the first stationary half ring does not rotate with respect to the support bar; and the first rotating half ring having at one end a first rotating portion, which rotates in close contact with the first fixing portion,
the second ring comprises the second stationary half ring having a second fixing portion with a polygonal hole, through which the support bar passes so that the second stationary half ring does not rotate with respect to the support bar; and the second rotating half ring having at one end a second rotating portion, which rotates in close contact with the second fixing portion, and
the third ring comprises the third stationary half ring having a third fixing portion with a polygonal hole, through which the support bar passes so that the third stationary half ring does not rotate with respect to the support bar; and the third rotating half ring having at one end a third rotating portion, which rotates in close contact with the third fixing portion.

9. The ring binder of claim 2, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

10. The ring binder of claim 2, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.

11. The ring binder of claim 3, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

12. The ring binder of claim 4, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

13. The ring binder of claim 5, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

14. The ring binder of claim 6, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

15. The ring binder of claim 7, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

16. The ring binder of claim 8, wherein the support bar comprises a head at one end to prevent the first ring from being separated from the first pipe and a nut at the other end to prevent the third ring from being separated from the second pipe, the other end of the support bar is directly welded to the third ring, or the support bar uses a riveting method for pressing one or both ends, so that the first ring and the third ring are not separated from the first and second pipes.

17. The ring binder of claim 3, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.

18. The ring binder of claim 4, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.

19. The ring binder of claim 5, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.

20. The ring binder of claim 6, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.

21. The ring binder of claim 7, wherein the first through third stationary half rings respectively comprise combining holes at their ends, and the first through third rotating half rings respectively comprise combining protrusions inserted into the combining holes at their ends, so that the ends of the stationary half rings are combined with and separated from the ends of the rotating half rings, respectively.
